(19) United States
(12) Patent Application Publication
(10) Pub. No.: US 2025/0068153 A1
(43) Pub. Date: Feb. 27, 2025

(54) OPERATOR ASSISTANCE IN AN AUTOMATION SYSTEM

(71) Applicant: ABB Schweiz AG, Baden (CH)

(72) Inventors: Saad Azhar, Västerås (SE); Duy Le, Hoa Thanh district, Tay Ninh Province (VN)

(21) Appl. No.: 18/723,968

(22) PCT Filed: Jan. 4, 2022
(86) PCT No.: PCT/EP2022/050048

§ 371 Date: Jun. 25, 2024

(51) Int. Cl. G05B 19/418

(52) U.S. Cl. CPC G05B 19/41885; G05B 2219/31454; G05B 2219/32128; G05B 2219/35494

(57) ABSTRACT

A consequence determining device for assisting an operator of an automation system, where the automation system implements a process flow that is displayed to the operator through a number of linked graphical objects representing elements in the process flow. The device obtains current status data of the current operation of the automation system, where the current status data includes current automation system settings, receives a simulation selection from the operator, which simulation selection involves a selection of a simulation with automation system settings that differ from the automation system settings used in the current operation, determines a difference in operation between the automation system as operated with the current automation system settings and the simulation automation system settings and displays the difference through manipulating graphical objects corresponding to elements in the process flow that experience the difference in operation.

### TECHNICAL FIELD

The present invention relates to a method, consequence determining device, computer program and computer program product for assisting an operator of an automation system as well as to an automation system comprising such as consequence determining device.

### BACKGROUND

Operators of automation systems may need to perform so called what-if analyses, where the consequences of a change in settings of the automation system are investigated, often using simulations.

WO 2005/109122 discloses a system that can be used for “what-if” analysis. According to the document the same graphical objects can be used in the design of different visualizations, such as process control and simulation. The graphical objects can for instance be used in a simulation view and an operator view, where a simulation view may be used for what-if simulations.

However, the consequences of the change in settings can often be hard to assess, because they are not readily apparent from such a simulation.

The present invention is concerned with improving the way such what-if analyses are being made, so that the operator can get a better overview of the consequences of a tentative change in the automation system and thereby can better determine an appropriate change of the automation system.

### SUMMARY

The present invention addresses this situation. The invention therefore aims at solving the problem of simplifying for an operator of an automation system to make sound automation system settings.

This object is according to a first aspect achieved through a method of assisting an operator of an automation system, where the automation system implements a process flow that is displayed to the operator through a number of linked graphical objects representing elements in the process flow, the method being performed by a consequence determining device and comprises:
obtaining current status data of a current operation of the automation system, where the current status data comprises current automation system settings,
receiving a simulation selection from the operator, which simulation selection involves a selection of a simulation with automation system settings that differ from automation system settings used in the current operation,
determining a difference in operation between the automation system as operated with the current automation system settings and the automation system settings used in the simulation, and
displaying the difference through manipulating or changing graphical objects corresponding to elements in the process flow that experience the difference in operation, in order to allow the operator to determine the consequences if the automation system settings of the simulation were to be used in the operation of the automation system.

The object is according to a second aspect achieved through a consequence determining device for assisting an operator of an automation system, where the automation system implements a process flow that is displayed to the operator through a number of linked graphical objects representing elements in the process flow, the consequence determining device being configured to:
obtain current status data of a current operation of the automation system, where the current status data comprises current automation system settings,
receive a simulation selection from the operator, which simulation selection involves a selection of a simulation with automation system settings that differ from automation system settings used in the current operation,
determine a difference in operation between the automation system as operated with the current automation system settings and the automation system settings used in the simulation, and
display the difference through manipulating or changing graphical objects corresponding to elements in the process flow that experience the difference in operation, in order to allow the operator to determine the consequences if the automation system settings of the simulation were to be used in the operation of the automation system.

The object is according to a third aspect achieved through an automation system comprising a consequence determining device according to the second aspect.

The object is according to a fourth aspect achieved through a computer program for assisting an operator of an automation system, where the automation system implements a process flow that is displayed to the operator through a number of linked graphical objects representing elements in the process flow, the computer program comprising computer program code configured to cause a consequence determining device to, when being loaded into the consequence determining device:
obtain current status data of a current operation of the automation system, where the current status data comprises current automation system settings,
receive a simulation selection from the operator, which simulation selection involves a selection of a simulation with automation system settings that differ from automation system settings used in the current operation,
determine a difference in operation between the automation system as operated with the current automation system settings and the automation system settings used in the simulation, and
display the difference through manipulating or changing graphical objects corresponding to elements in the process flow that experience the difference in operation, in order to allow the operator to determine the consequences if the automation system settings of the simulation were to be used in the operation of the automation system.

The object is according to a fifth aspect achieved through a computer program product for assisting an operator of an automation system, the computer program product being provided on a data carrier comprising the computer program with computer program code according to the fourth aspect.

The current status data may be obtained when the automation system is operated using the current automation system settings.

According to a variation of the first aspect, the method further comprises determining if the difference in operation leads to a risk threshold being crossed and warning the operator in case of such a crossing.

According to a corresponding variation of the second aspect the consequence determining device is further configured to determine if the difference in operation leads to a risk threshold being crossed and warning the operator in case of such a crossing.

The risk threshold may be linked to an operation and/or location in the automation system and the warning may be made in relation to a graphical object representing the operation and/or location.

The displaying of the difference may additionally only be made if the difference in the operation between the automation system as operated with the current automation system settings and the automation system settings used in the simulation cross a difference threshold.

The process flow may additionally have a direction and the simulation may have at least one automation system parameter setting for an operation and/or location in the process flow that differs from a corresponding parameter in the current operation. In this case the difference in operation may comprises a difference in operation downstream of the operation and/or location with the at least one parameter setting.

The selection of a simulation may be the selection of an existing, previously made simulation. Alternatively, the selection of a simulation may comprise a selection of automation system settings and the performing of a simulation of the operation of automation system using the selected automation system settings.

In the latter case, the method may further comprise simulating the operation of the automation system using the selected automation system settings.

In the latter case the consequence determining device may be configured to perform a simulation of the operation of automation system using the selected automation system settings.

The selection of an automation system setting may additionally be a selection of a desired result of the process flow and the simulation may be a simulation using automation parameter settings, set by the consequence determining device, that achieves the desired result.

Alternatively, the selection of automation system settings may comprise a selection of a setting of at least one automation system parameter of an operation and/or location in the automation system and the performing of a simulation of the operation of the automation system using said at least one automation system parameter setting. In this case it is additionally possible that all other parameter settings than those set by the operator are current parameter settings from the current automation system settings.

The method may further comprise presenting the operator with a group of automation system parameters that the operator is allowed to set, and the at least one automation system parameter being selected by the operator may be an automation system parameter in the group.

In this case the consequence determining device may be further configured to present the operator with a group of automation system parameters that the operator is allowed to set, and the at least one automation system parameter being selected by the operator may be an automation system parameter in the group.

The present invention has a number of advantages. It allows an operator to better understand the consequences of the application of a selected simulation in relation to the current operation of the automation system, which simplifies the analysis. Thereby the likelihood that the operator makes an erroneous change may also be decreased.

### BRIEF DESCRIPTION OF THE DRAWINGS

The present invention will in the following be described with reference being made to the accompanying drawings, where

FIG. 1 schematically shows an automation system in the form of a mining system comprising a number of operations,

FIG. 2 schematically shows one realization of a consequence determining device used in the automation system,

FIG. 3 shows a number of steps being performed by the consequence determining device in a method of assisting an operator of the automation system,

FIG. 4 schematically shows a first screen being presented to the operator by the consequence determining device for performing an exemplary what-if analysis,

FIG. 5 schematically shows a second screen being presented to the operator by the consequence determining device during the exemplary what-if analysis,

FIG. 6 schematically shows a third screen being presented to the operator by the consequence determining device during the exemplary what-if analysis,

FIG. 7 schematically shows a fourth screen being presented to the operator by the consequence determining device during the exemplary what-if analysis,

FIG. 8 schematically shows a fifth screen being presented to the operator by the consequence determining device during the exemplary what-if analysis, and

FIG. 9 shows a data carrier with computer program code, in the form of a CD-ROM disc, for implementing the machine set point determining device.

### DETAILED DESCRIPTION

In the following, a detailed description of preferred embodiments of an automation system as well as a method, consequence determining device, computer program and computer program product for assisting an operator of the automation system will be given.

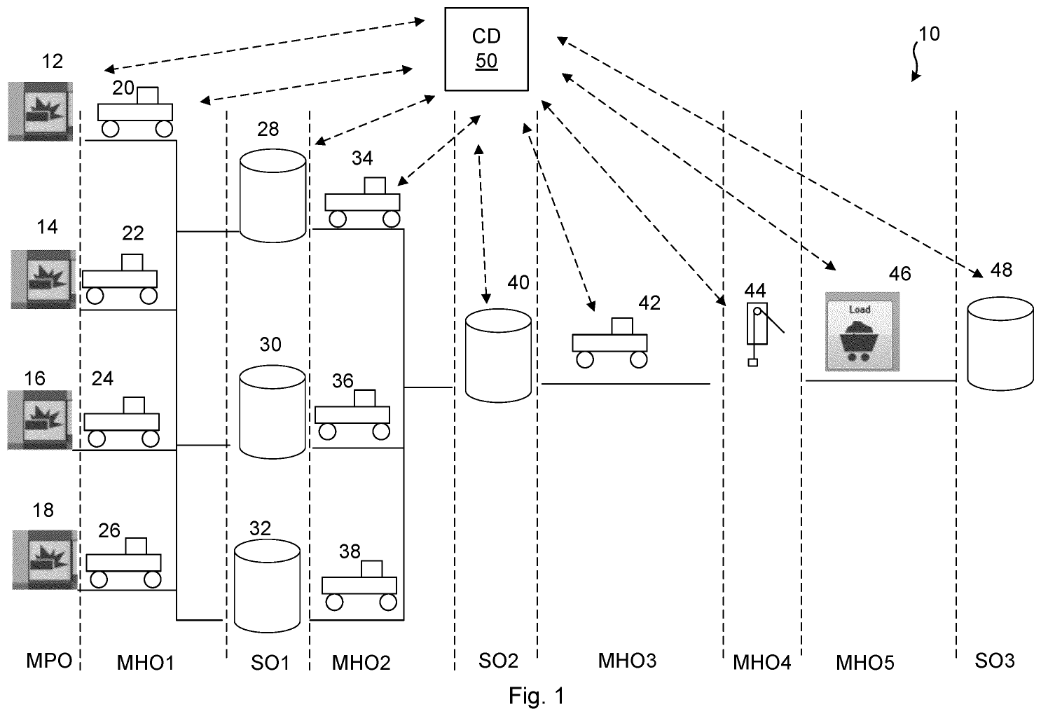

FIG. 1 schematically shows an exemplifying automation system 10, which in this case is a mining system. However, it should be realized that this is merely one example of an automation system in which aspects of the present disclosure may be implemented. Examples of other types of automation systems are systems such as paper and pulp production systems, oil and gas production systems and electrical power transmission systems.

In such a system there may be an operation process flow in which a number of operations are performed. As an example, relating to mining, the operations comprise a material production operation MPO, which in the case of mining may be a first ore producing operation that as an example is a blasting operation. In the present example there is a first production point 12, a second production point 14, a third production point 16 and a fourth production point 18, where in the present example the material production operation MPO, which in this case is blasting, is carried out at each of the production points 12, 14, 16 and 18.

After the material production operation MPO follows a first material handling operation MHO1 for moving material away from the production points 12, 14, 16 and 18. The first material handling operation MHO1 may be considered to be a first material transporting operation, which may additionally be a first ore transporting operation involving the transporting of ore using equipment such as Load Haul and Dump (LHD) vehicles. In the figure there is a first LHD vehicle 20 moving material from the first production point 12, a second LHD vehicle 22 moving material from the second production point 14, a third LHD vehicle 24 moving material from the third production point 16 and a fourth LHD vehicle 26 moving material from the fourth production point 18. The first material handling operation MHO1 is followed by a first storing operation SO1, which in this case is a first intermediate material storing operation. This first storing operation SO1 may involve storing the material in material storages, which in this case may be so-called ore passes. There is here a first material storage 28 at a first material storage point, a second material storage 30 at a second material storage point and a third material storage 32 at a third material storage point. The material storages 28, 30 and 32 may be connected to the material production points 12, 14, 16 and 18 via a first road network. The LHD vehicles 20, 22, 24, and 26 of the first material handling operation MHO1 may thereby transport material to any of the three material storages 28, 30 and 32 of the first material storing operation MSO1.

After the first storing operation SO1 follows a second material handling operation MHO2 for moving material away from the first, second and third material storages 28, 30 and 32. The second material handling operation MHO2, which may be a second material transporting operation, also involves the transporting of material using LHD vehicles. In the figure there is a fifth LHD vehicle 34 moving material from the first material storage 28, a sixth LHD vehicle 36 moving material from the second material storage 14 and a seventh LHD vehicle 32 moving material from the third material storage 32. The second material handling operation MHO2 is followed by a second storing operation SO2, which in this case is a second intermediate material storing operation. This intermediate material storing operation SO2 may also involve storing of the material in material storages, which material storages may likewise be one or more ore passes if the material is ore. There is here a fourth material storage 40 at a fourth material storage position. The fourth material storage 40 may be connected to the first, second and third material storages 28, 30 and 32 via a second road network. The first, second and third LHD vehicles 34, 36 and 38 may thereby transport material to the fourth material storage 40 of the second storing operation SO2 from any of the three material storages 38, 30 and 32 of the first storing operation SO1. After the second storing operation SO2 follows a third material handling operation MHO3 for moving material away from the fourth material storage 40, which third material handling operation MHO3 may be a third material transporting operation involving a transporting using transporting equipment such as trucks, trains, wagons or conveyor belts. In the present example the transporting involves the use of an eighth LHD vehicle 42. Thereafter follows a fourth material handling operation MHO4, which may be a fourth material transporting operation that as an example is a hoisting operation using hoisting equipment 44. A hoisting operation may also be considered to be an ore handling operation. The eighth LHD vehicle 42 may thereby use a track, such as a road, between the fourth material storage 40 and the hoisting equipment 44.

After the fourth material handling operation MHO4 follows a fifth material handling operation MHO5 for moving material away from the hoisting equipment 44. This is done using a transportation device 46 that in this case is a wagon that moves along a track in the form of a rail. After the fifth material handling operation MHO5 there is finally a third storing operation S03 involving storing material in a fifth material storage 48. The wagon 46 is moved along the path, which path thereby runs between the hoisting equipment 44 and the fifth material storage 48.

There is finally a control device CD 50 which receives measurements from different equipment involved in the automation process and which may also transmit commands to them. Such exchange of signals is made between all the equipment at each of the operations and the control device 50. However, the signals are only shown for the first production point 12 in the material production operation MPO, the first LHD vehicle 20 in the first material handling operation MHO1, the first material storage 28 in the first storing operation SO1 and the fifth LHD vehicle 34 in the second material handling operation MHO2. The control device 50 may be implemented through a so-called Supervisory Control and Data Acquisition (SCADA) device.

It should here be realized that the automation system 10 in FIG. 1 is a mere example and that further or fewer operations may be included. It is also possible with additional types of operations, such as charging, drilling and shotcreting. As mentioned earlier it is also possible that the automation system is another type of automation system than a mining system

The automation system 10 provides an automation or process flow starting at the material production operation MPO and ending with the third storing operation SO3. There is thus a production flow from the material production operation MPO to the third storing operation SO3.

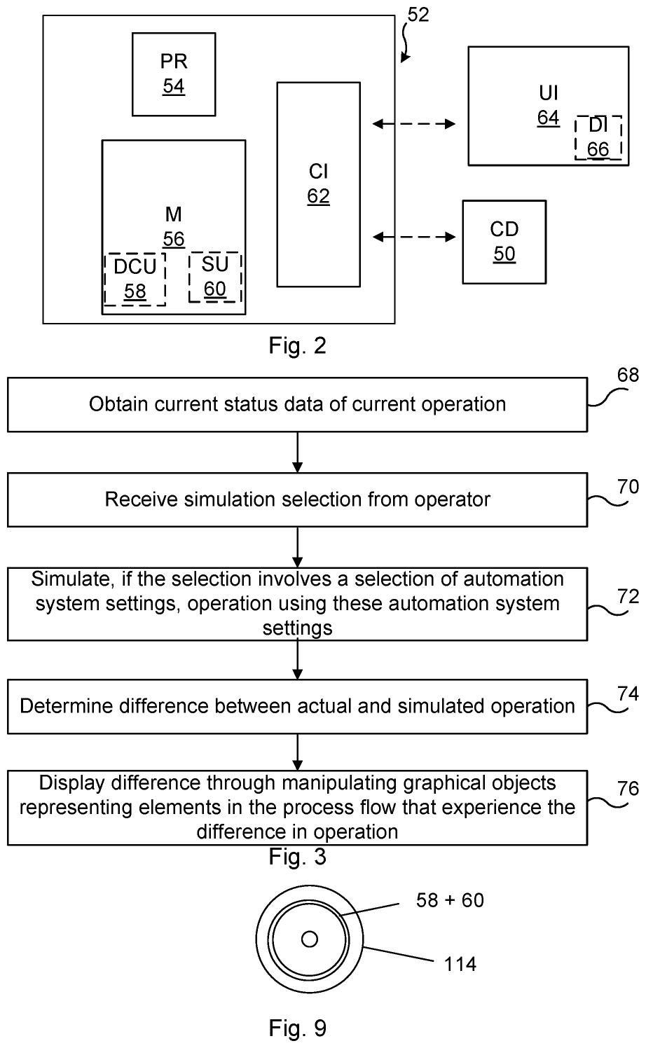

FIG. 2 shows a block schematic of a consequence determining device 52 used in different aspects of the present disclosure, The consequence determining device 52 comprises a processor PR 54 and a memory M 56 comprising a displaying control unit DCU 58 and a simulation unit SU 60, which are both provided in the form of computer program code, software code or computer instructions. The processor 54 implements a display control function when running the computer program code of the displaying control unit 58 and performs a simulation function when running the computer program code of the simulation unit 60.

There is also a communication interface CI 62 that the consequence determining device 52 uses for communication with a user interface UI 64 as well as with the control device CD 50. The user interface 64, which comprises a display DI 66, is shown as being provided outside of the consequence determining device 52. However, it should be realized that it may as an alternative be a part of the consequence determining device 52.

In some variations the user interface 64 is a touch screen via which data can be presented for an operator by the consequence determining device 52 as well as via which data can be entered by the operator. It should be realized that in other variations the display 66 may only be a display and the inputs provided through a keypad or a keyboard, a trackball, a joystick or some other buttons.

A method of assisting an operator of the automation system will now be described with reference being made to FIG .3, which shows a number of steps being performed by the consequence determining device 52.

Use of simulations has been a major development in optimizing complex automation tasks. These simulations are often seen in applications such as scheduling, transportation, resource usage, and more complex multi-objective optimizations. Often, these simulations are designed, implemented, configured, and executed by specialists who understand the application domain as well as the complexities of these simulations and their underlying models. The average benefactor of results from such simulation, however, is typically an operator who utilizes these results in day-to-day decision making to keep the operations running at desired performance and output levels. The operators do not always possess an understanding of the underlying models for simulation; hence they are not equipped to configure or fine tune these simulations either. However, they are able to provide information in terms of the process (or application) they are overseeing e.g., running a conveyor belt at 20% reduced speed or adding another truck to transport material from point A to B. To achieve this, a system may be provided that:
provides a means to issue such instructions (an interface or language of sorts),
translates these instructions into a format that the simulation algorithm understands,
analyses these instructions in the context of the larger process and provide feedback, and
visualizes the outcome of the simulation run based on the instructions and allows modifications.

With the above-mentioned system, the operators can command the system to quickly generate multiple simulations of possible future states of the process based on current data and different configurations of parameters. The operators can then assess the results of these simulations to decide the most suitable way to adjust the parameters to achieve the desired outcomes. This approach will also reduce the cognitive load on the operator during decision making by offloading the different parameter configurations to the simulation.

The consequence determining device 52 is based on modular, object-oriented simulation models of the different entities involved. A top-level controller, the control device 50, is responsible for dynamically invoking the relevant models and serves as a bridge between the user interface 64 and connected systems to retrieve data to be used for simulation parameters.

The consequence determining device 52 uses a simulation function provided by the simulation unit 60 and associated visualizations provided by the displaying control unit 58 presenting the operator with current bottlenecks and a range of parameters that may be modified. The starting point for the operation of the consequence determining device 52 is thereby the current system settings of an actual current operation of the automation system 10, which involves current parameters of different operations. The operator may then change these parameters as desired on a visual presentation of the process being run by the automation system 10 and may also run a simulation using these parameter changes. The display control unit 58 gives feedback on the anticipated impact of these changes. The operator can either repeat this process or save the configuration to run the simulations.

The operator has access to a screen of the current operation of the automation system and can open an existing simulation configuration or create a new one from the current state. When the operator opens an existing simulation or creates a new simulation, a simulation screen that is based on the current operation screen is presented to the operator by the display control unit 58. In this simulation screen, the simulation unit 60 may indicate which configuration parameters are possible to change. The changes may be presented in a process-centric way considering any limitations and constraints. The operator with his or her knowledge of the process may then be able to manipulate these parameters to simulate a future state and scenario.

The display control unit 58 keeps tracks of the changes made by the operator and provides feedback to the operator on the anticipated impact on the overall process and its outcomes. The display control unit 58 cascades the effects of these parameter changes in the connected parts of the process. Any limits or constraints are also accounted for in the simulation. All of this is achieved by incorporating individual simulation models for each of the configurable elements in the process within the overall process level simulation.

The operator configures the parameters using visual interactions with the consequence determining device 52, entering values if required, and the display control unit 58 provides visual feedback and confirmation against any changes. Then, these human-readable configurations will be mapped to corresponding parameters that will be fed into the simulation models to generate simulations. The simulated state of the process is visualized by indicating which elements in the process were manipulated for the current simulation as well as how the changes of these elements affect the outcome of the process and any connected KPIs (Key Performance Indicators).

At this point, the operator can either accept the changes, run the simulation, and apply it to the process being run by the automation system or continue to try out different scenarios until the desired outcome is seen in the simulation. This way, a “what-if” approach can be employed to test different ideas before executing them in the live process. The consequence determining device 52 can also perform a backward simulation: the operator indicates a desired outcome on the user interface 64, then commands the consequence determining device 52 to simulate different configuration approaches for the process to achieve the desired outcome. The operator can examine the generated approaches to choose the most suitable one. The operator can playback the simulated scenarios, where changes in model parameters will be mapped to corresponding process elements and visually reflected on the user interface 64, compare them to the current state and verify if the new solution is more optimized before deciding a course of action.

Put differently, the automation system 10 implements a process flow that is displayed to the operator via the user interface 64 by the display control unit 58 through a number of linked graphical objects representing elements (operations, paths, equipment and/or locations) in the process flow. As there is a process flow, the process flow also has a direction.

In operation the control device 50 may control the automation system 10 using current automation system settings. In the context of the mining system of FIG. 1, such current automation system settings may comprise automation system parameters such as the amount of blasting to be made, the time intervals between blasting, how many pieces of transporting equipment that are to be used, which degree they are to be filled with material and the speed with which they are to be moved. The current automation system settings may also comprise the current result of the process flow such as the current amount of material produced and the current degree of utilization of equipment.

The simulating unit 60 may obtain current status data of the actual current operation of the automation system from the control device, step 68, where current status data comprises the above-mentioned current automation system settings. The current status data may additionally comprise data that cannot be set by the operator, for instance current material storage levels as well as current health and performance data of equipment in the automation system 10. Thereby the current status data comprises data defining the current status of the operation or process being run by the automation system 10.

The simulating unit 60 may additionally receive a simulation selection from the operator, step 70, which is either a selection of a previous existing simulation or the automation system settings of a new simulation and the selection to perform a simulation using the selected automation system settings. When the simulation selection involves the selection of an automation system setting, it may be a setting of a desired result of the process flow or a selection of at least one parameter setting of an operation or location in the process flow. In relation to an operator selection of at least one parameter, the display control unit 58 of the consequence determining device 52 may additionally present the operator with a group of automation system parameters that the operator is allowed to set, and the at least one automation system parameter being selected by the operator may be an automation system parameter in this group.

If the operator selection involves a selection of a new simulation, the simulating unit 60 simulates the operation of the automation system using the automation system settings provided by the operator, step 72. If the automation system setting comprises a setting of at least one parameter of the automation system 10, the simulating of the operation of the automation system may use the at least one parameter in the simulation, where all other parameter settings may be the parameter settings of the current operation. In case the automation system settings are the settings of a desired result of the process, the simulating unit 60 of the consequence determining device 52 may make parameter settings that achieves the desired result of the process flow. It may thereby change one or more of the parameter settings of the current operation of the automation system.

The simulating unit 60 also determines the difference in the operation of the automation system 10 between the actual current operation according to the current system settings and the simulation, step 74, where, as was indicated above, the simulation may be a new simulation using the received automation system settings or an existing previously known simulation.

Information about the difference is then provided to the displaying control unit 58, which goes on and displays the difference through manipulating the graphical objects in the process flow representing elements that experience the difference in operation or for which there is a difference in operation, step 76. The difference in operation for a graphical object may then be obtained through detecting a change in the status data of a piece of equipment corresponding to or using the element that the graphical object depicts. Thereby the operator is allowed to determine the consequences of the automation system settings used in the simulation.

The simulation may have at least one automation system parameter setting for an operation and/or location in the process flow that differs from a corresponding parameter in the current operation and the difference in operation may comprise a difference in operation downstream of the operation and/or location with the at least one parameter setting.

The simulation unit may additionally determine if the difference in operation and/or status leads to a risk threshold being crossed and the operator may be warned in case there is such a crossing. This may be done through the display control unit 58 displaying such warnings, where the warning may be linked to the elements of the automation system where the threshold is crossed. The risk threshold may thereby be linked to an operation or location in the automation system and the warning may be made in relation to the graphical object representing the operation or location.

It is additionally possible that the displaying of the difference is only made if the difference in the operation between the automation system as operated with the current automation system settings and the automation system settings used in the simulation cross a difference threshold. The operator may in this case also be allowed to set the difference threshold.

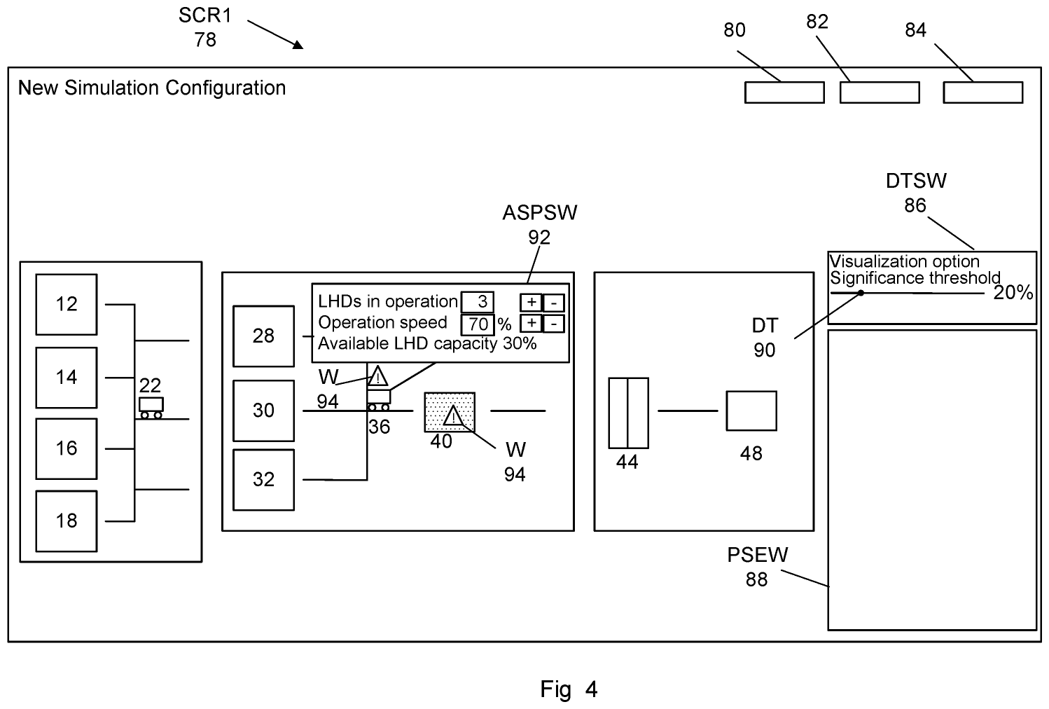

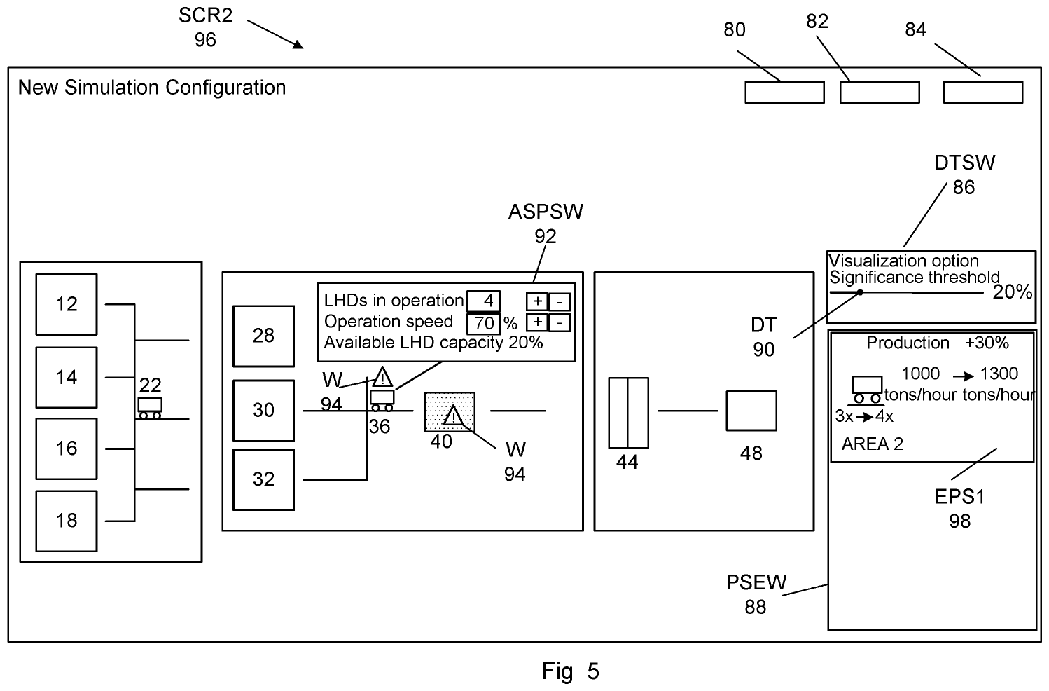

One variation in the assisting of an operator that is specific to mining will now be described with reference being made to FIGS. 4, 5, 6, 7 and 8, where FIG. 4 schematically shows a first screen being presented to the operator by the consequence determining device 52 for performing an exemplary what-if analysis and FIGS. 5, 6, 7 and 8 show a second, third, fourth and fifth screen being presented to the operator by the consequence determining device 52 during the exemplary what-if analysis.

The exemplifying process is the flow of material in a mine, such as the transportation of ore and rock, as a process with different elements like conveyor belts, LHDs (Load, Haul and Dump machine), trucks, and mine hoist.

The overall process according to the current operation is represented in a first screen SCR1 78 in the user interface 64, see FIG. 4. The screen includes a simulation activation button 80, a configuration saving button 82 and a simulation ending button 84. There is also a difference threshold selection window DTSW 86 with a difference threshold DT 90 set by the operator, which difference threshold 90 is a threshold above which the effects of a difference in operation caused by the use of a new parameter setting of the simulation are to be displayed to the operator. Thereby the effects of a difference in operation that is below the difference threshold 90 will not be displayed. As an example, this threshold is set to 20%. There is also a parameter selection effect window PSEW 88 where the parameter that is changed by the operator and the effects of this parameter change may be shown.

Different graphical objects represent production points 12, 14, 16 and 18 and storages (or stockpiles) 28, 30, 32, 40 and 48 in the mine. The lines between objects representing the elements show the flow of material such that thicker lines represent more flow as compared to thinner lines. Along the flow lines, objects representing the transportation medium 22 and 36 are also visualized, e.g., trucks, LHDs, conveyor belts etc. When an element in the process is selected it may be highlighted and its connected flow lines may be highlighted as well.

Upon selection, a details panel may be shown at the bottom of the view (not shown) in order to show further information about the selected element. This information may include material details like quantities and concentration, as well as source of the material for instance a part of the mine or production point, and from a particular blast. This information may be human-readable, meaning it can be understood by operators without specialized expertise in simulation modelling. It is not necessarily the same as the corresponding parameters fed into the simulation model. Any information, errors or warnings W 94 that the system identifies as relevant for the material flow may also be visualized on the process and may also be shown in the details panel.

The underlying simulation system implemented through the simulating unit 60 is connected to simulation models of the different elements in the process and is able to retrieve from and/or feed configuration parameters to these models. The operator's configurations on human-readable information on the interface will be mapped to corresponding parameters of the models. Such mapping can be pre-configured in the system. The simulation model takes the current state of the process as input when configuring simulations as well. This way, when the simulation configuration view of the first screen SCR1 78 is being displayed, the operator can see the current state from which a simulation has to be generated. The underlying element specific models may also inform the overall simulation (and thus the operator) which automation system parameters can be configured. As an example, the operator is informed about which parameters that can be set in relation to the second material handling operation MHO2 in an automation system parameter setting window ASPSW 92, which in this case is shown relation to the sixth LHD 36.

In the automation system parameter setting window 92, the currently used parameter settings are initially shown. According to this exemplifying initial automation system parameter setting, three LHDs are currently used in the second material handling operation MHO2 and the material handling operation operates with an operation speed of 70%. As can also be seen, the operator may increase and decrease the number of LHDs that are employed in the second material handling operation MHO2 as well as increase and decrease the operation speed. The operator may then make a change of at least one parameter. Such a change of one parameter is shown in a second screen SCR2 96 in FIG. 5, where the operator has made a first exemplifying automation system parameter setting ASPS1 97, where the number of LHDs has been increased from three to four. This parameter setting configuration may then be saved through the operator pressing button 82. A simulation using the first parameter setting may also be made through the operator pressing the button 80. The effect of the first parameter setting EPS1 98 is also shown in the parameter setting effect window PSEW 88, where it can be seen that the parameter setting change from three to four LHDs leads to an increase in production from 1000 to 1300 tons of material per hour.

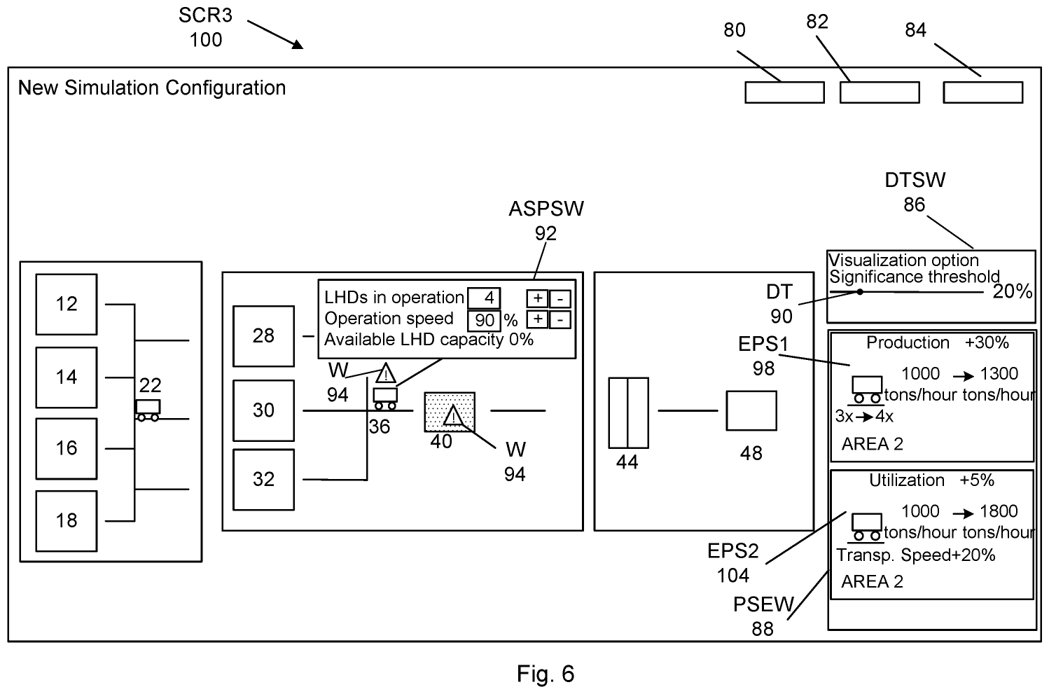

As an example, shown in a third screen SCR3 100 in FIG. 6, the operator may also make a second automation system parameter setting. In the present example the operator has additionally increased the operation speed of the second material handling operation MHO2 from 70% to 90% in the automation system parameter setting window 92, where the effect EPS2 104 of this second parameter change is also shown in the parameter selection effect window 88. It can be seen that utilization is increased from 1000 tons per hour to 1800 tons per hour with the 20% operational speed increase.

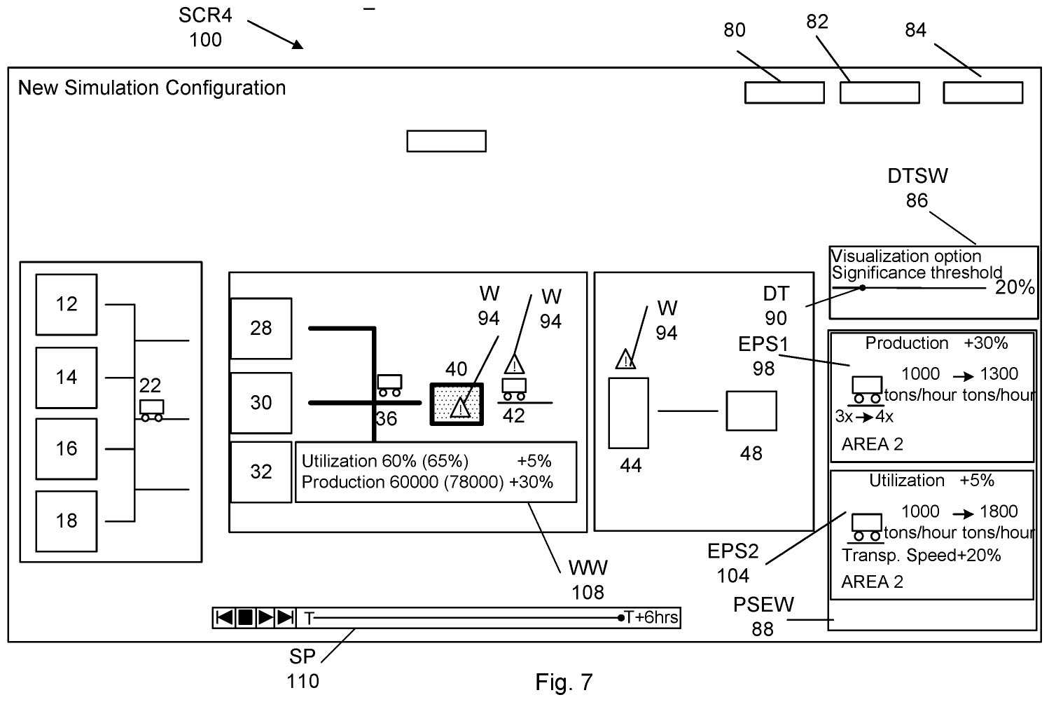

When the operator makes changes in the parameters, which are taking effect when the simulation button 80 is pressed, these are fed to the simulation engine and on-the-fly results are reported back to the operator. Since the changes are cascaded, the operator can also see changes in the performance of connected elements and hence the overall process. As an example, shown in a fourth screen SCR4 in FIG. 7, it can be seen that the parameter changes change the second material handling operation MHO2. It thus differs from the current second material handling operation and in the present case it also differs more than the amount set by the difference threshold DT 90, which in this case is indicated through the link, here the road network, between the first storing operation SO1 at the material storages 28, 30 and 32 and the second storing operation SO2 at the material storage 40 being manipulated. In this case it may be highlighted. However also the second storing operation SO2 is affected, which is shown through the fourth material storage 40 also being highlighted.

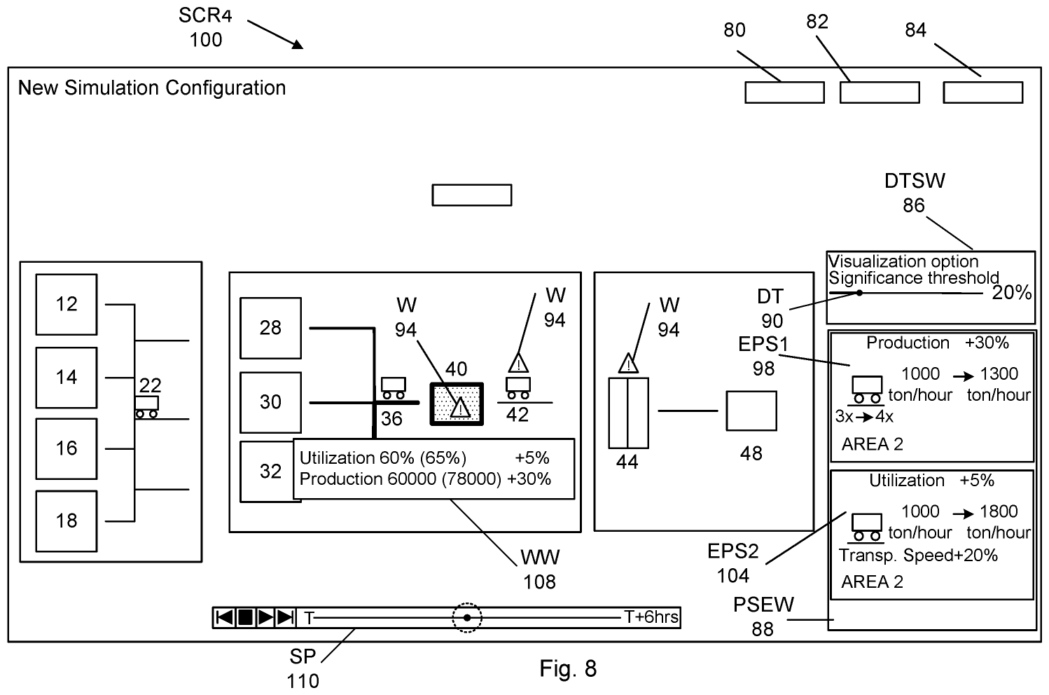

In FIG. 8 there is also shown a simulation player SP 110. The operator may ‘seek’ through the simulation by help of a timeline in the simulation player SP 110 to see how the process is expected to run should the simulated parameters be applied to the actual process. This may highlight ‘when’ and ‘where’ these changes will have an impact. This is shown in FIG. 8.

If the simulation identifies potential problems (e.g., further bottlenecks) after parameters are modified, warning messages may be raised and visualized on the process view as well. Such a warning message in relation to the fourth material storage 40 in the second storing operation SO2 is shown in a warning window WW 108 in FIGS. 7 and 8.

Some parts of the process may take long time to operate at their maximum level. These situations can be supported by visualizing the trends along with the timeline to show how the process outcome changes with time.

In the example given above the operator made a new simulation. As was mentioned earlier, it is also possible that an earlier made simulation may be treated in the same way as the new simulation.

The consequence determining device 52 can also perform a backward simulation: the operator indicates a desired outcome on the user interface 64 and then commands the consequence determining device 52 to simulate different configuration approaches for the process to achieve the desired outcome. The operator can then examine the generated approaches to choose the most suitable one to control the process.

After having run one more simulations, the operator may then select to apply the automation system settings of a simulation in the running of the automation system.

The novel ways to visually encode different aspects of process simulations enable operators to intuitively configure and preview different parameters for simulation and eventual decision making in process control. The operator can thus see the consequence of potentially applied automation system settings. Thereby it is easier for him or her to make the right decisions of if and how the process is to be changed. Also, the operators' time and cognitive workload in assessing different process control strategies is reduced. Thereby mistakes in decision making may be minimize. Thus, help is given that may increase the productivity in process control.

The displaying control unit and the simulating unit of the consequence determining device may be implemented using software. They may thus be implemented using computer program code, which may be provided on one or more data carriers which perform the displaying control and simulation functions when the program code thereon is being loaded into one or more computers. One such data carrier 114 with such computer program code 58 and 60, in the form of a CD ROM disc, is schematically shown in FIG. 9. Such computer program may as an alternative be provided on a server and downloaded therefrom into the one or more computer.

1. A method of assisting an operator of an automation system, where the automation system implements a process flow that is displayed to the operator through a number of linked graphical objects representing elements in the process flow, the method being performed by a consequence determining device and comprises:
obtaining current status data of a current operation of the automation system, said current status data including current automation system settings,
receiving a simulation selection from the operator, which simulation selection involves a selection of a simulation with automation system settings that differ from automation system settings used in the current operation,
determining a difference in operation between the automation system as operated with the current automation system settings and the automation system settings used in the simulation, and
displaying said difference through manipulating graphical objects corresponding to elements in the process flow that experience the difference in operation, in order to allow the operator to determine the consequences if the automation system settings of the simulation were to be used in the operation of the automation system.

2. The method according to claim 1, further comprising determining if the difference in operation leads to a risk threshold being crossed and warning the operator in case of such a crossing.

3. The method according to claim 2, wherein the risk threshold is linked to an operation and/or location in the automation system and the warning is made in relation to a graphical object representing the operation and/or location.

4. The method according to claim 1, wherein the displaying of said difference is only made if the difference in the operation between the automation system as operated with the current automation system settings and the automation system settings used in the simulation cross a difference threshold.

5. The method according to claim 1, wherein the process flow has a direction and the simulation has at least one automation system parameter setting for an operation and/or location in the process flow that differs from a corresponding parameter in the current operation and the difference in operation includes a difference in operation downstream of said operation and/or location with said at least one parameter setting.

6. The method according to claim 1, wherein the selection of a simulation comprises a selection of automation system settings and the performing of a simulation of the operation of automation system using the selected automation system settings, the method further including simulating the operation of the automation system using the selected automation system settings.

7. The method according to claim 6, wherein the selection of automation system settings includes a selection of a setting of at least one automation system parameter of an operation and/or location in the automation system and the performing of a simulation of the operation of the automation system using said at least one automation system parameter setting.

8. The method according to claim 7, further comprising presenting the operator with a group of automation system parameters that the operator is allowed to set, and the at least one automation system parameter being selected by the operator is an automation system parameter in said group.

9. The method according to claim 6, wherein the selection of automation system settings is a selection of a setting of a desired result of the process flow and the simulation is a simulation using automation parameter settings, set by the consequence determining device, that achieves the desired result.

10. The method according to claim 1, wherein the selection of a simulation is the selection of an existing, previously made simulation.

11. A consequence determining device for assisting an operator of an automation system, where the automation system implements a process flow that is displayed to the operator through a number of linked graphical objects representing elements in the process flow, the consequence determining device being configured to:
obtain current status data of a current operation of the automation system, said current status data including current automation system settings,
receive a simulation selection from the operator, which simulation selection involves a selection of a simulation with automation system settings that differ from automation system settings used in the current operation,
determine a difference in operation between the automation system as operated with the current automation system settings and the automation system settings used in the simulation, and
display said difference through manipulating graphical objects corresponding to elements in the process flow that experience the difference in operation, in order to allow the operator to determine the consequences if the automation system settings of the simulation were to be used in the operation of the automation system.

12. An automation system comprising a consequence determining device for assisting an operator of an automation system, where an automation system implements a process flow that is displayed to the operator through a number of linked graphical objects representing elements in the process flow, the consequences determining device being configured to:
obtain current status data of a current operation of the automation system, said current status data including current automation system settings,
receive a simulation selection from the operator, which simulation selection involves a selection of a simulation with automation system settings that differ from automation system settings used in the current operation,
determine a difference in operation between the automation system as operated with the current automation system settings and the automation system settings used in the simulation, and
display said difference through manipulating graphical objects corresponding to elements in the process flow that experience the difference in operation, in order to allow the operator to determine the consequences if the automation system settings of the simulation were to be used in the operation of the automation system.

13. A computer program for assisting an operator of an automation system, where the automation system implements a process flow that is displayed to the operator through a number of linked graphical objects representing elements in the process flow, said computer program including a computer program code configured to cause a consequence determining device to, when being loaded into the consequence determining device:
obtain current status data of a current operation of the automation system, said current status data including current automation system settings,
receive a simulation selection from the operator, which simulation selection involves a selection of a simulation with automation system settings that differ from automation system settings used in the current operation,
determine a difference in operation between the automation system as operated with the current automation system settings and the automation system settings used in the simulation, and
display said difference through manipulating graphical objects corresponding to elements in the process flow that experience the difference in operation, in order to allow the operator to determine the consequences if the automation system settings of the simulation were to be used in the operation of the automation system.

14. A computer program product for assisting an operator of an automation system, said computer program product being provided on a data carrier comprising said computer program with computer program code where the automation system implements a process flow that is displayed to the operator through a number of linked graphical objects representing elements in the process flow, said computer program including a computer program code configured to cause a consequence determining device to, when being loaded into the consequence determining device:
obtain current status data of a current operation of the automation system, said current status data including current automation system settings,
receive a simulation selection from the operator, which simulation selection involves a selection of a simulation with automation system settings that differ from automation system settings used in the current operation,
determine a difference in operation between the automation system as operated with the current automation system settings and the automation system settings used in the simulation, and
display said difference through manipulating graphical objects corresponding to elements in the process flow that experience the difference in operation, in order to allow the operator to determine the consequences if the automation system settings of the simulation were to be used in the operation of the automation system.

15. The method according to claim 2, wherein the displaying of said difference is only made if the difference in the operation between the automation system as operated with the current automation system settings and the automation system settings used in the simulation cross a difference threshold.

16. The method according to claim 2, wherein the process flow has a direction and the simulation has at least one automation system parameter setting for an operation and/or location in the process flow that differs from a corresponding parameter in the current operation and the difference in operation includes a difference in operation downstream of said operation and/or location with said at least one parameter setting.

17. The method according to claim 2, wherein the selection of a simulation comprises a selection of automation system settings and the performing of a simulation of the operation of automation system using the selected automation system settings, the method further including simulating the operation of the automation system using the selected automation system settings.
